(19) United States
(12) Patent Application Publication
(10) Pub. No.: US 2006/0272210 A1
(43) Pub. Date: Dec. 7, 2006

(54) Smart garden devices and methods for growing plants

(75) Inventors: W. Michael Bissonnette, Boulder, CO (US); Robert E. Wainwright, Longmont, CO (US); Carson Payne, Niwot, CO (US); John Thompson, Boulder, CO (US); Curt Morgan, Huntington Beach, CA (US); Sylvia Bernstein, Boulder, CO (US)

Correspondence Address: AeroGrow International, Inc., Suite 201, 900 28th St., Boulder, CO, 80303, US

(73) Assignee: AeroGrow International, Inc., Boulder, CO (US)

(21) Appl. No.: 11/455,364

(22) Filed: Jun. 19, 2006

Related U.S. Application Data
(63) Continuation-in-part of application No. 10/528,110, filed on Jul. 15, 2005.
(60) Provisional application No. 60/691,372, filed on Jun. 17, 2005.

(51) Int. Cl. A01G 31/02

(52) U.S. Cl. 47/69

(57) ABSTRACT

This invention provides smart garden devices for hydroponics growing systems, wherein the devices include a means for delivering electricity to the smart garden device; at least one timer; and means for determining, receiving, sending, or processing data regarding the status of a component or characteristic of the hydroponics device. This invention also provides smart garden kits and methods for using smart garden devices for growing plants.

### CROSS-REFERENCE TO RELATED APPLICATIONS

This application is a Continuation-in-Part Application of U.S. application Ser. No. 10/528,110, filed Mar. 16, 2005, which is a National Stage Application under 35 U.S.C. 371 of International Application Serial No. PCT/US2004/30168, filed Sep. 15, 2004; that also claims priority to U.S. Provisional Application Ser. No. 60/691,372, filed Jun. 17, 2005, all of which are incorporated herein by reference to the extent that there is no inconsistency with the present disclosure.

### FIELD OF THE INVENTION

This invention is in the fields of plant agriculture, home gardening, indoor gardening, and hydroponics.

### BACKGROUND

Hydroponics is the cultivation of plants without soil. Hydroponics provides healthier, disease-free plants, faster than growing in soil. In soil-less culture, plants are instead cultivated using a liquid solution of water and nutrients. There are 6 basic types of hydroponic systems: Wick, Raft (also called Water Culture), Ebb and Flow (also called Flood & Drain), Drip, Nutrient Film Technique, and Aeroponic. There are hundreds of variations on these basic types of systems, and most hydroponics systems can be described as a variation or combination of these six types.

Plants need light, water, nutrients, oxygen, carbon dioxide, appropriate temperatures, and time in order to grow. This invention provides devices and methods for easily growing a wide variety of plants that are healthier and more nutritious than plants grown in soil. This invention provides a novel hydroponics system that is self-contained, useful for germination through harvest, useful for cuttings, is useful with low technology components, is useful for single plants through agricultural production, and provides more oxygen to the plant roots than other hydroponic systems.

A challenge in consumer level hydroponics is incorporating a reliable method for reminding the user to regularly care for the growing plants. This invention provides a reliable method for reminding a user to care for the growing plants.

Soil-less cultivation of plants can provide many advantages over traditional soil-based cultivation. In a soil-less medium, delivery of nutrients to plant roots can be regulated more easily in order to optimize plant growth. This is done by precisely controlling the composition of a nutrient solution, and then by controlling precisely the frequency that plant roots are exposed to the nutrient solution. Plants grow faster in a soil-less environment because plant roots are not required to expend the energy to push soil particles, and therefore have more energy available for growing.

In hydroponics techniques, plants are grown in the absence of soil and roots are maintained in a substantially liquid environment or humid environment. Instead of soil, the root mass of the plant is either supported within an essentially homogeneous synthetic or natural medium, which is either porous or particulate, or the root mass is immersed within a liquid, while the foliage of the plant is allowed to extend upward from the root support medium where it is exposed to light. Meanwhile, the root structure is exposed to a nutrient solution which may be either wicked up to the roots by means of a porous wicking medium or circulated by means of a pump irrigation system. Either way, nutrient delivery to the root mass may be carefully regulated.

### SUMMARY OF THE INVENTION

This invention provides smart garden devices for a hydroponics device, the hydroponics device having at least one characteristic or component, the smart garden device comprising: means for delivering electricity to the smart garden device; at least one timer; and means for determining, receiving, sending, or processing data regarding the status of the component or characteristic of the hydroponics device.

### BRIEF DESCRIPTION OF THE DRAWINGS

FIGS. 1A-D are illustrations showing a perspective view, a front view, a side view, and a back view, respectively, of a device, for growing a plant or germinating a seed into a plant, of this invention.

FIGS. 2A-C are illustrations showing a perspective view, a front view, and a back view, respectively, of a device, for growing a plant or germinating a seed into a plant, of this invention.

FIG. 5A is an illustration of a top perspective view of the portion of the device shown in FIG. 4A. FIG. 5B is an illustration of a perspective ghost view (dashed lines) of the base, including the smart garden, of the device shown in FIGS. 1A-D.

FIGS. 9A-E are illustrations showing a perspective view, a front view, a back view, a side view, and a side view with the arm extended, respectively, of the photoradiation apparatus shown in FIGS. 1A-D.

FIG. 10 is an illustration showing a front view of a smart garden display panel of this invention.

### DETAILED DESCRIPTION OF THE INVENTION

As is used in the art and as used herein, a “vessel” is able to contain a liquid and optionally has a bottom wall and/or one or more side walls. The bottom wall can have vertical as well as horizontal components as in a hemisphere. A side wall has a vertical component. Preferably the vessel is not permeable to photoradiation that would interfere with plant growth or would promote growth of unwanted organisms such as algae.

Vessels of this invention are removably coverable by a cover that has at least one plant opening for removably suspending a plant. Preferably covers are not permeable to photoradiation that would interfere with plant growth or would promote growth of unwanted organisms such as algae. Preferably the devices of this invention are also not permeable to liquids except at the plant opening(s) and any other opening functioning in liquid transfer, such as a liquid fill inlet or outlet. Optionally the cover comprises two or more layers, e.g., an upper and lower cover. When a device of this invention comprises an upper cover and a lower cover, both covers have at least one set of plant openings that are horizontally aligned.

As used herein, “hydroponic” refers to plant growing techniques that do not use soil. As used herein, “optimal growth” refers to plant growth that is optimized to achieve a selected set of characteristics, e.g., fruit harvest, root harvest, leaf harvest, flower production and/or size, and longevity.

As used in the art and as used herein, “nutrients” refers to atoms and molecules in an available form necessary for plant growth in addition to oxygen, hydrogen, and water including calcium, magnesium, sodium, potassium, nitrogen, phosphorus, sulfur, chlorine, iron, manganese, copper, zinc, boron, and molybdenum. Nutrient formulations and recipes are known in the art (see, for example, Resh H. M (2001) Hydroponic Food Production, Sixth Addition, Woodbridge Press Publishing Company, Santa Barbara, Calif., USA). It is known in the art that a liquid that contacts a plant, e.g., liquid used to supply nutrients to a plant, is preferably within a particular pH range. Optimal pH ranges for a variety of plants are known in the art. As used herein, “photoradiation” refers to wavelengths of light of sufficient quantity and quality that allow a plant to grow, as is known in the art. It is known in the art which quantities and wavelengths of photoradiation are preferred for many plants.

The term “growing a plant” as used in herein refers to the process which takes place when appropriate conditions such as water, photoradiation, gas containing oxygen and carbon dioxide, and nutrients are provided to a plant tissue, whether a seed, a cutting, transplant, bulb, tuber, runner, or a plant having roots, resulting in an increase in the mass of plant tissue. The term “cutting” as used herein refers to plant tissue with or without roots taken from an already existing plant.

The term “germinating a seed into a plant” as used herein refers to the process which takers place when appropriate conditions such as water, photoradiation, gas containing oxygen and carbon dioxide are provided to the seed, resulting in the emergence of a plant embryo from the seed.

The term “growth medium” as used herein refers to any material which permits the growth of plant material or the germination of a seed to take place.

The term “dissolved oxygen concentration” as used herein refers to the amount of molecular oxygen which is contained in a liquid.

As used herein, the term “open conduit” refers to a conduit which is absent a portion of its outer perimeter.

As used in the art and as used herein, “channel” refers to a form having one or more side walls and optionally one or more bottom walls, wherein the channel is able to route a liquid from a first location to one or more second locations.

Soil-less media for growing plants are generally composed of materials that have moderate water-retention characteristics, allowing liquid nutrient solution to flow readily to plant roots and then to drain away so that roots are not constantly soaked in a liquid that may foster rot or the growth of damaging fungi. Soil-less media may be composed of any number of suitable porous substances such as peat moss, wood bark, cellulose, pumice, plastic or polystyrene pellets, vermiculite or foam, for example.

As used herein, the term “enclosed” refers to the state of having substantially all of the surfaces of a vessel defined by a solid object.

As used herein, the term “characteristic” refers to qualities or attributes which describe the physical condition or state of existence of the device, including, but not limited to: timing cycle, need for nutrients, need for liquid within the device, humidity, root density, nutrient concentration, pH, dissolved oxygen concentration, turbidity of liquid, incident photoradiation, temperature, and plant mass.

As used herein the term “component” refers to physical elements of the device including, but not limited to: timers, photoradiation sources, and pumps.

As used herein, the term “delivering electricity” refers to providing means for allowing electricity to enter and drive the electrical components of the device. The most likely form this electricity delivery will take is to supply a set of wires which can be plugged into household alternating current, but adapting the device for use with a battery operated system is also contemplated.

As used herein, the term “displaying” refers to a visual means of communication of information, such as an illuminated lamp, LCD or liquid level gauge. As used herein, the term “two week cycle” refers to a timing cycle which extends approximately two weeks in duration.

As used herein, the term “liquid nutrient solution” refers to a liquid which contains nutrients in solution or suspension or in a mixture, or in a combination of solution, suspension or mixture. As used herein, the term “nutrient concentration” refers to the concentration of nutrient in the liquid within the device including that which is available for delivery to plant tissue.

As used herein the term “determining, receiving, sending or processing data” refers to one or more operations to a data set which results in the creation of an additional data set. The additional data set can be a copy of the first data set in a new location.

As used herein, the term “programmable storage device” refers to any storage device such as a computer chip, for example, which is capable of storing data and information for executing a program. As used herein the term “preprogrammed storage device” refers to any programmable storage device which is programmed to carry out specific functions.

As used herein, the term “root density” refers to the proportion of root mass in a specific volume, such as g/mm³, for example. As used herein, the term “turbidity” refers to the quantity of suspended material in a liquid, as measured by a photodensitometer.

As used herein, “adjuvants” refers to additives that enhances the effectiveness a composition.

The components illustrated in the drawings are numbered as shown in Table 1 below.

TABLE 1
Drawing Elements

| Item | Number |
|---|---|
| 1 | plant growing device |
| 3 | cover |
| 4 | opening |
| 12 | vessel |
| 33 | liquid level gauge |
| 100 | hydroponic device with photoradiation apparatus and smart garden |
| 101 | base |
| 102 | door |
| 103 | nutrient inlet cover |
| 104 | means for lifting cover |
| 107 | optional power cord exit |
| 114 | leg |
| 117 | stand |
| 121 | means for receiving vessel |
| 220 | artificial photoradiation hood |
| 221 | adjustable photoradiation arm |
| 222 | vent holes |
| 223 | means for adjusting photoradiation hood height |
| 125 | photoradiation apparatus |
| 126 | extended arm |
| 127 | extension unit height |
| 128 | extension notch |
| 140 | smart garden display panel |
| 141 | transformer |
| 142 | circuit board power |
| 143 | circuit board controller |
| 144 | timing cycle selection button for photoradiation source and/or |
| | pump |
| 145 | add nutrients reset button |
| 146 | add nutrients flashing signal |
| 147 | add water flashing signal |
| 148 | timing cycle selection name that lights up |
| 149 | photoradiation cycle override button |

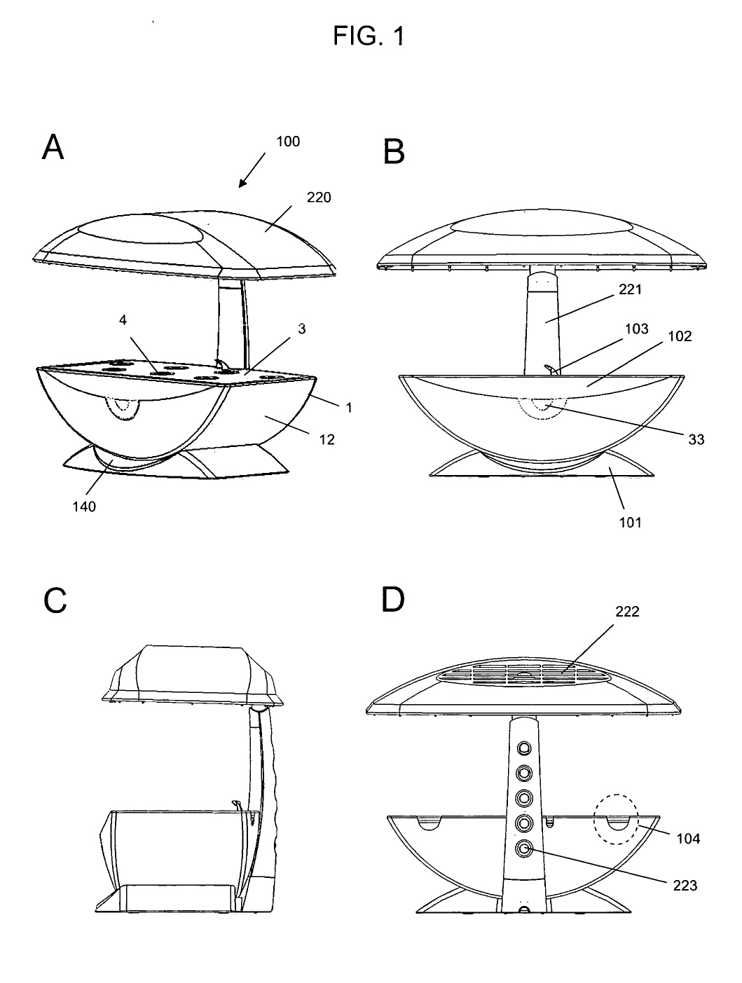

FIGS. 1A-D are illustrations showing a perspective view, a front view, a side view, and a back view, respectively, of a device 100, for growing a plant or germinating a seed into a plant with a photoradiation apparatus and smart garden, of this invention. The device shown in FIGS. 1A-D includes a photoradiation apparatus for delivering artificial photoradiation with a base 101 and a notched arm 221 for changing the height 223 of the photoradiation hood 220 as the plants grow (not shown). The photoradiation hood 220 has vent holes 222 for heat produced by the bulbs (not shown) to escape. The cover 3 of the vessel 12 has seven openings 4 for plants. The plant-growing device 1 has door 102 for adding liquid and viewing roots. Below the door 102 is a liquid level gauge. In the cover 3 there is a nutrient inlet cover 103. The cover 3 has two tabs and the vessel has two cut-outs and indentations, which together serve as a means for lifting the cover 104. The smart garden's display panel 140 is shown in outline.

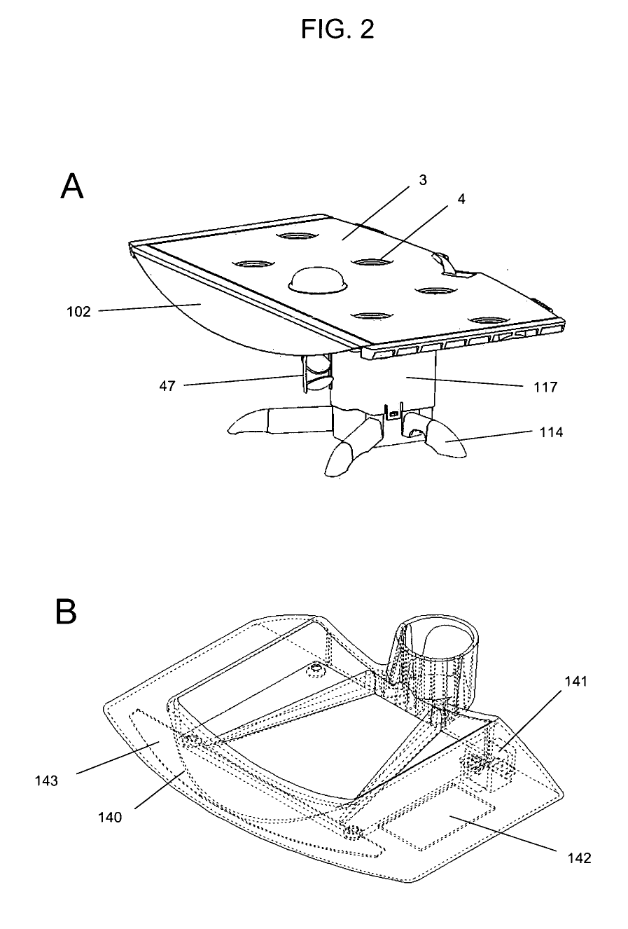

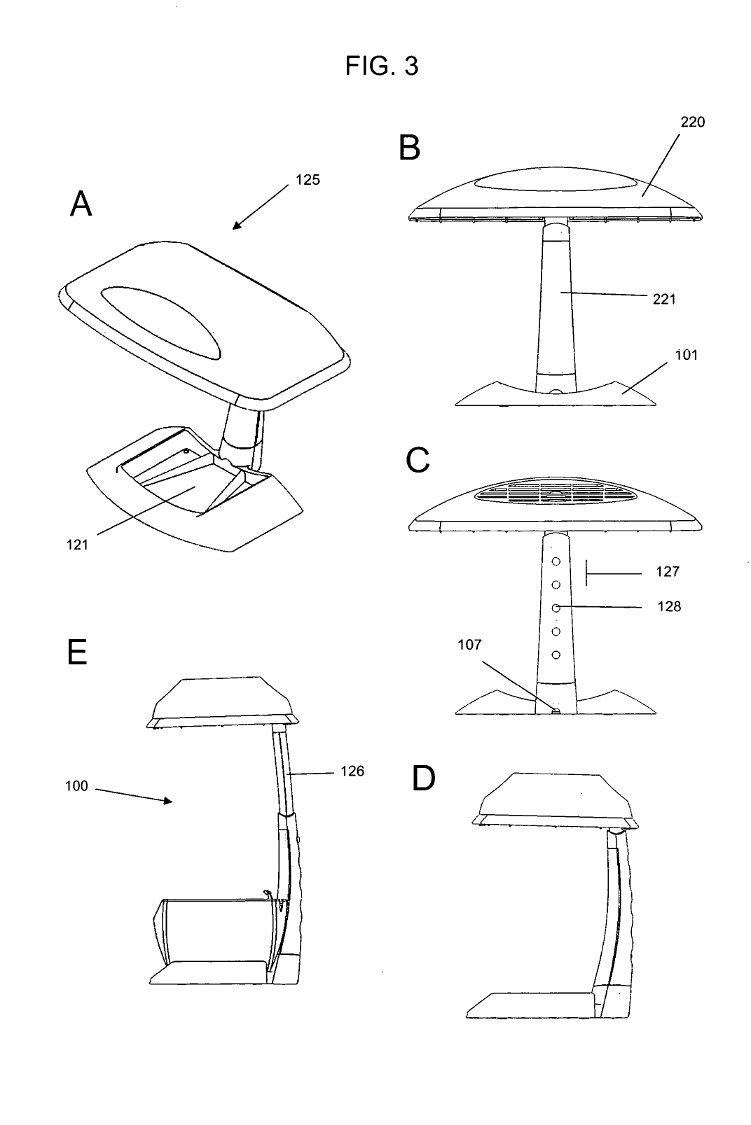

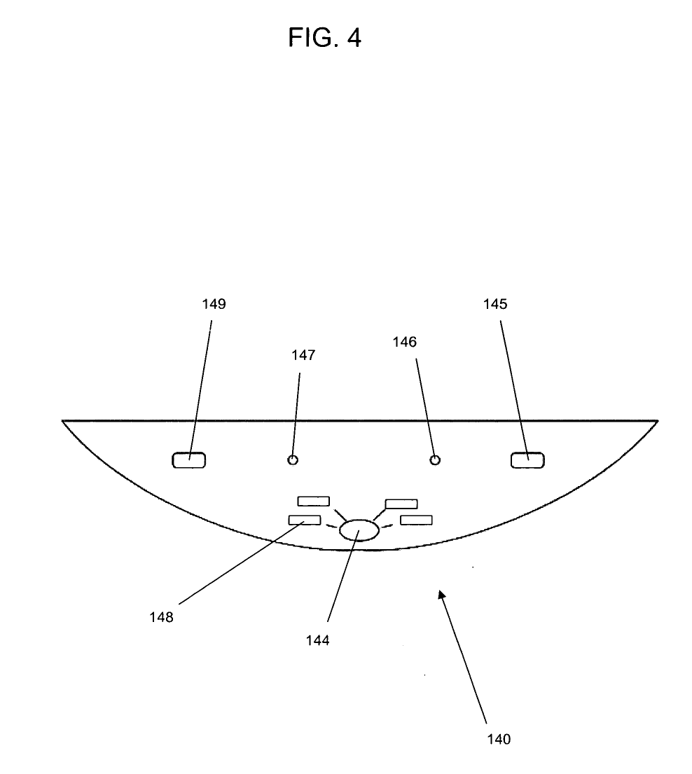

FIG. 2A is an illustration of a top perspective view of a portion of the device shown in FIG. 1. FIG. 2A shows a six uncovered plant openings 4 and one covered by a germination cap (not labeled). The door 102 is attached to the cover 3, and the stand 117, of which three legs 114 are visible. One terraced aerator 47 is visible. FIG. 2B is an illustration of a perspective ghost view (dashed lines) of the base, including the smart garden, of the device shown in FIGS. 1A-D. The base is an optional support for a device of this invention and a photoradiation apparatus (not shown). This base contains a smart garden display panel 140 which also serves as a data entry panel. Behind the panel 140 is a circuit board controller 143 for the smart garden device. The side of the base contains the circuit board for the electric power 142 of the device which is connected to a transformer 141.

FIGS. 3A-E are illustrations showing a perspective view, a front view, a back view, a side view, and a side view with the arm extended, respectively, of the photoradiation apparatus 125 shown in FIGS. 1A-D. FIG. 3A shows a device or vessel receiving means 121. FIG. 3B shows the base 101, adjustable photoradiation arm 221, and photoradiation hood 220. FIG. 3C shows the arm extension notches 128 and the height of an extension 127. A power cord exit 107 is also visible. FIG. 3E shows the device 100 with the arm completely extended 126.

FIG. 4 is an illustration showing a front view of a smart garden display panel 140 of this invention. The panel 140 contains a means for inputting photoradiation cycle override data 149, a means for alerting a user to add liquid 147 to the device, a means to alert a user to add nutrient 146 to the device, and means for inputting nutrient cycle reset data 145. Optionally the adding liquid 147 and adding nutrient 146 signal means flash a light to alert a user. The panel 140 also has a timing cycle selection input and display means 144. This data is used to select the cycle of the pump and/or the photoradiation apparatus. The cycle selected can be displayed by lighting up the name 148 of the selected cycle.

This invention provides a smart garden device for a hydroponics device, the hydroponics device having at least one characteristic or component, the smart garden device comprising: means for delivering electricity to the smart garden device; at least one timer or clock or connection to a clock or timer; and means for determining, receiving, sending, or processing data regarding the status of the component or characteristic of the hydroponics device.

In an embodiment, the device also comprises a means for displaying the status of the component or characteristic. In an embodiment, the device also comprises a means for displaying the status of requirement to add nutrient or for displaying the status of requirement to add liquid or both. In an embodiment, the device also comprises a means for displaying the status of requirement to add liquid nutrient solution. In an embodiment, the device also comprises a timer for display of a requirement to add nutrient. In an embodiment, the timer has a two-week cycle.

In an embodiment, the hydroponics device also has a second component or characteristic, the smart garden device also comprising a means for determining, receiving, sending, or processing data regarding the status of the second component or characteristic of the hydroponics device or the smart garden device also comprising a means for displaying the status of the second component or characteristic or both. In an embodiment, the first and second components or characteristics are the same. In an embodiment, the first and second components or characteristics are different. In an embodiment, the component or characteristic is selected from the group consisting of: timers, timing cycles, photoradiation sources, pumps, need for nutrient, need for liquid within the device, humidity, root density, nutrient concentration, dissolved oxygen concentration, turbidity of liquid within the device, incident photoradiation, temperature, pH, and plant mass. In an embodiment, the liquid is water. In an embodiment, the liquid is liquid nutrient solution.

In an embodiment, the means for determining, receiving, sending, or processing data comprises a preprogrammed storage device. In an embodiment, the preprogrammed storage device is a circuit board. In an embodiment, the preprogrammed storage device is a computer chip. In an embodiment, the means for determining, receiving, sending, or processing data comprises a programmable storage device. In an embodiment, the programmable storage device is a circuit board. In an embodiment, the programmable storage device is a computer chip.

In an embodiment, the smart garden device comprises a means for determining, receiving, sending, or processing data regarding the status of two or more components or characteristics of the device and a means for displaying the status of two or more components or characteristics of the device.

In an embodiment, the smart garden device comprises a means for receiving data regarding the status of a photoradiation source, resetting a timer for the requirement to add nutrient, and selection of a timing cycle for a photoradiation source and/or a pump. In an embodiment, the smart garden device comprises a timer for a photoradiation source and a pump. In an embodiment, the smart garden device comprises a plurality of timing cycles for the timer. In an embodiment, the timing cycles are selected from the group consisting of: 24 hours on, 24 hours off, 20 hours on and 4 hours off, 18 hours on and 6 hours off, 16 hours on and 8 hours off, 14 hours on and 10 hours off, and 12 hours on and 12 hours off.

In an embodiment, the smart garden device further comprises a liquid level gauge and a means for detecting a signal from the liquid level gauge. In an embodiment, the means for detecting a signal from a liquid level gauge is a photocell. In an embodiment, the smart garden device also comprises a means for sending data to or receiving data from an external programmable storage device. In an embodiment, the external programmable storage device is accessed through the internet. This invention provides machine-readable storage devices, program storage devices, and programmable storage devices having data and methods for diagnosing physical conditions.

This invention also provides methods for using hydroponics devices and for growing plants and germinating seeds into plants using the smart garden devices of this invention.

This invention provides a reliable method for reminding a user to care for the growing plants. This invention provides a device having a means for alerting a user when to add water and a means for alerting the user when to add food (nutrients and/or fertilizer). This invention provides a device for determining, receiving, sending, or processing data regarding a photoradiation source and a means for regulating the duration and frequency that photoradiation is delivered, and also optionally a means for overriding the regulating means. This invention also optionally provides a device for regulating the duration and frequency of a liquid delivery means.

This invention provides devices useful with and/or within gardens as well as gardening devices, including hydroponic devices, containing the devices of this invention. The methods and devices of this invention are useful for quickly growing healthy, productive plants. The devices of this invention include small, self-contained, portable devices for a home garden through large devices useful in the agricultural industry. The method and devices of this invention require no prior experience with growing plants, but also provide satisfying experiences and harvests for master gardeners. The methods and devices of this invention are useful for growing ornamental plants as well as plants for culinary use. The devices of this invention are useful for growing plants at all stages, including from seed through harvests, growing plants from seed for transplant, growing plants from seedlings, and growing cuttings. Reproductive and vegetative tissues including flowers, shoots, leaves, and roots can all be produced and harvested using the methods and devices of this invention. When using the methods and devices of this invention, the volume of the vessel is selected for the type and number of plants to be grown.

This invention provides methods, devices, and kits that are useful for growing plants hydroponically or with soil. This invention provides a device for growing a plant or germinating a seed into a plant. The devices of this invention are useful for growing more than one plant or seed.

In an embodiment of this invention, the gas comprises oxygen gas. In an embodiment of this invention, the liquid comprises water. In an embodiment of this invention, the liquid also comprises one or more plant nutrients. In an embodiment of this invention, the liquid comprises water and sufficient quantities of all the macronutrients and micronutrients necessary for optimal plant growth.

In an embodiment of this invention, the device or method includes: means for detecting, providing, and/or modifying nutrients, photoradiation quantity and/or quality, temperature, fluid level, dissolved oxygen, pH of the liquid, means for detecting and quantitating unwanted organisms (e.g., anaerobic bacteria and algae), and/or means for reporting results of various assays. Optionally, a device of this invention comprises a means for preventing overfilling the liquid. The means for assaying and/or modifying can include use of machine readable storage devices, program storage devices, and data sets regarding which plants are being grown and optimal nutrient concentration, temperatures, pH levels, etc.

In an embodiment of this invention, the method for growing plants is a hydroponic method. In an embodiment of this invention, the method comprises providing plant growth components comprising nutrients, oxygen, carbon dioxide, and photoradiation and delivering the plant growth components to the plant.

In an embodiment of this invention, the method further comprises adding one or more nutrients to the liquid. In an embodiment of this invention, the adding is performed about once a week or once every two weeks.

This invention provides a method for delivering oxygen to a plant comprising: providing a plant with at least one root or a cutting that will develop a root; providing a liquid capable of having oxygen dissolved therein; providing a gas comprising oxygen gas; providing a means for contacting and fluidly contacting the liquid with the gas whereby a portion of the oxygen gas dissolves in the liquid thereby forming oxygenated liquid; providing a means for elevating and elevating a portion of the oxygenated liquid above the remaining oxygenated liquid; allowing the portion of oxygenated liquid to fall through the gas into the remaining oxygenated liquid whereby more oxygen gas dissolves in the liquid thereby forming super-oxygenated liquid; and contacting the root with the oxygenated liquid or the super-oxygenated liquid; whereby oxygen is delivered to the plant. In an embodiment of this invention, sufficient oxygen is delivered to the plant that the plant grows. In an embodiment of this invention, sufficient oxygen is delivered to the plant that the plant optimally grows.

Optionally the liquid falling through said gas into said remaining portion of oxygenated liquid increases the humidity level of said gas, and the method further comprises contacting said root with said humidity. Optionally the method further comprises contacting said root with said gas comprising oxygen. Optionally the method further comprises allowing said root to grow in said oxygenated or super-oxygenated liquid.

In an embodiment of this invention, the vessel and the cover form an enclosed chamber, except for the plant openings.

In an embodiment of this invention, the first and second portions of liquid are delivered simultaneously. In an embodiment of this invention, the means for delivering liquid and the means for delivering photoradiation are scheduled to operate simultaneously.

When making or selecting a net basket of this invention, the channel locations and shapes are selected to prevent a contained and supported wet growth medium from completely clogging any of the channels. When using a hydroponics device or net basket of this invention, a growth medium is selected for the plant that is to be grown and the delivery schedule of the liquid. In an embodiment of this invention, the growth medium is not soil-less and comprises soil. In an embodiment, the growth medium includes a variety of materials useful for growing plants. In an embodiment, plant nutrients are in the growing medium.

The methods and devices provided by this invention are useful with and without soil. The methods are easy to follow and the devices are easy to use. Most plants, including universally believed to be difficult growers such as orchids can be grown in the devices of this invention. The devices of this invention form enclosed chambers for root nourishment and growth. The devices are self-contained and provide water, photoradiation, and plant nutrients with little care and maintenance by a user. Optionally means are provided for alerting a user to add water, liquid, and/or plant nutrients. The devices optionally include photoradiation sources, and a means for regulating the frequency and duration of photoradiation delivery.

The devices of this invention are useful for growing plants from seed through harvest and through senescence or death. The devices of this invention are useful for growing transplants, cuttings, somatic embryos, tubers, and runners.

Optionally the hydroponics devices of this invention also include a battery to maintain the functioning of the timer(s) during short intervals in which electricity is not supplied, such as during power outages or during moving the device to a different location. Optionally an external electric cord connects the base to the photoradiation hood. The cord can be unplugged and an extension cord added to suspend the photoradiation hood at a higher elevation than permitted by the arm.

In an embodiment, the smart garden includes a means for communicating with an external programmable storage device directly and/or through the internet. The smart garden devices of this invention are useful alone and in combination with other devices, in the practice of this invention. External liquid reservoirs are useful with the devices and methods of this invention.

The devices of this invention are useful with gardening systems and devices, including hydroponics devices. The devices of this invention are useful with systems and devices having a component or characteristic selected from the group consisting of: timers, timing cycles, photoradiation sources, pumps, need for nutrient, need for liquid within said device, humidity, root density, nutrient concentration, dissolved oxygen concentration, turbidity of liquid within said device, incident photoradiation, temperature, and plant mass. Hydroponics devices useful in the practice of this invention include devices described in PCT/US04/30168, the AeroGarden™ (AeroGrow International, Inc., Boulder, Colo.), and hydroponic gardening devices available on the market and as yet to be invented. The devices of this invention are useful with hydroponics nutrients described in U.S. Ser. Nos. 11/321,023 and 11/321,910.

In an embodiment of this invention, the hydroponics device is a consumer device that is useful in the home for growing food. In an embodiment, it is a self-contained device, can be placed on a kitchen counter, is consumer-friendly and easy to use, and can fit under standard kitchen cabinets.

In an embodiment, the device is composed of two printed circuit boards that are connected to a low voltage power supply, a pump, and a lamp in triac power control circuitry, and a microprocessor, user switch, and LED display circuits. The components necessary to make devices of this invention are known in the art. The devices of this invention are useful for hydroponic, aeroponic, and soil gardens known in the art and as yet to be invented. Seeds, nutrients, photoradiation devices, circuit board components, etc. known in the art and as yet to be invented are useful in the practice of this invention.

In an embodiment, the device also contains additional cycles and settings that may be hidden from the consumer. In an embodiment, the device meets all requirements of Underwriter's Laboratories.

### EXAMPLE 1

A smart garden device of this invention was placed within a hydroponics garden, similar to the garden described in PCT/US04/30168. A salad greens lettuce seed kit (AeroGrow International, Inc., Boulder, Colo.) containing pre-seeded seed pods and nutrient tablets was utilized to start the garden. The seed pods were planted in the garden, about 14.5 ounces of water were added, two nutrient tablets were dropped into the garden, and the garden was plugged in. The lights came on. Water was pumped up to the seed pods. The nutrient tablets began to dissolve. The plant type was selected as lettuce/salad greens. The nutrient reset button was pressed. The light cycled on and off as appropriate for the selected plant type, on about 16 hours and off about 8 hours. The timing of the light on/off was reset to go on at 6 am and off at 10 pm. In 24 hours the seeds germinated. In 4 days the grow domes were removed. In two weeks the add nutrient and the add water lights flashed. Nutrient tablets and water were added and the add nutrient button was pressed. Lettuce was harvest by 3 weeks, for salads, sandwiches, garnish, etc. The add water light flashed again at 3 weeks and 1 day. Water was added and the add water light went off.

### EXAMPLE 2

A device of this invention was made to have the components and characteristics as described below.

The device has a controller which includes the following: (means for displaying status, including) 5 mode LED's (Green), 1 Fluid Low LED (Red), 1 Nutrient Refill LED (RED); (means for determining status) 1 Fluid Low Detector (Magnetic Reed Switch); (means for receiving data) 3 Operator Switches (Lamp, Mode, Refill Reset); (means for sending data) 3 Control Outputs (Grow Lamp, Main Pump, Reservoir Pump); (means for delivering or receiving electricity) Battery Back-up (maintains timing for 1 to 2 weeks [OTP] or 6 to 12 months [mask MCU]) and/or connection to standard, ungrounded cord and plug.

Upon power up (with no battery connected) the unit begins at plant type tomato (Mode 1), at the beginning of the Lamp and Pump “On” time. If a battery is installed and the insulating pull-tab is removed timing will continue during main power outages. While on battery power, all LED's and devices (pumps, grow lamps) will be off. When main power resumes all LED's and devices will return to their proper states, including the mode selected prior to power outage. Timing and actions will continue as though no power outage had occurred. For units with the Microchip processors battery shelf life is several years and keep alive life is six to twelve months. The battery shelf life is several years and keep alive life is one to two weeks.

Each of the three switches can detect either a short, long, or extra-long press. For each short press and release of the lamp switch the grow lamps will be toggled from off to on, or on to off. The lamps will remain in this state until the next commanded on or off time occurs. At this time the lamps will return to the proper on or off state. An extra long lamp switch press will set the grow lamps to the beginning of their on time. For each short press of the Mode Switch the mode (as indicated by the green mode LED) is advanced to the next mode (1-2-3-4-5-1). When modes are changed the grow lamp state will not change until the new selected mode lamp command for on or off occurs at the proper hour.

If the add nutrient and water level low led are flashing a short press of the “Reset” switch will reset the 14-day timer and turn off the flashing LED's. If the LED's are not flashing then a short press of the “Reset” switch is ignored.

The fluid low sensor is a magnetic reed switch that closes in the presence of a magnetic field. Whenever the reed switch is closed the associated red LED (water level low) will be flashing, when the reed switch is open the LED will be off. The water level low LED is also flashed in conjunction with the add nutrient LED.

The add nutrient LED will flash when its timer reaches 14 days. Flashing will continue until the timer is reset by a press on the reset switch. The water level low LED is always flashed in conjunction with the add nutrient LED.

A reservoir pump cycle is initiated after the fluid low sensor has been high for one hour and then low for 30 seconds. Times are selected from the ranges listed below in Table 2.

TABLE 2

| | Pump Hours | Grow Lamp |
|---|---|---|
| Mode | on of each 24 | hours on each 24 |
| 1 Tomato | 18-22 | 14-18 |
| 2 Lettuce | 20-24 | 16.5 |
| 3 Herbs | 16-18 | 16-18 |
| 4 Flowers | 18-22 | 14-16 |
| 5 Strawberry | 13-16 | 13-16 |

Although this invention has been described with respect to specific embodiments, it is not intended to be limited thereto, and various modifications which will become apparent to the person of ordinary skill in the art are intended to fall within the scope of the invention as described herein, taken in conjunction with the accompanying drawings and the appended claims.

All references cited are incorporated herein by reference to the extent that they are not inconsistent with the disclosure herein.

1. A smart garden device for a gardening or hydroponics device, said gardening or hydroponics device having at least one characteristic or component, said smart garden device comprising:
a) means for delivering electricity to said smart garden device;
b) at least one timer; and
c) means for determining, receiving, sending, or processing data regarding the status of said component or characteristic of said gardening or hydroponics device.

2. The smart garden device of claim 1 also comprising a means for displaying the status of said component or characteristic.

3. The smart garden device of claim 2 comprising a means for displaying the status of requirement to add nutrient or for displaying the status of requirement to add water or both.

4. The smart garden device of claim 2 comprising a timer for display of a requirement to add nutrient.

5. The smart garden device of claim 4 wherein said timer has a two-week cycle.

6. The smart garden device of claim 1, wherein said hydroponics device also has a second component or characteristic, said smart garden device also comprising a means for determining, receiving, sending, or processing data regarding the status of the second component or characteristic of said hydroponics device or said smart garden device also comprising a means for displaying the status of said second component or characteristic or both.

7. The smart garden device of claim 1 wherein said component or characteristic is selected from the group consisting of: timers, timing cycles, photoradiation sources, pumps, need for nutrient, need for liquid within said device, humidity, root density, nutrient concentration, dissolved oxygen concentration, turbidity of liquid within said device, incident photoradiation, temperature, and plant mass.

8. The smart garden device of claim 1 wherein said means for determining, receiving, sending, or processing data comprises a preprogrammed or programmable storage device.

9. The smart garden device of claim 8 wherein the preprogrammed storage device is a circuit board.

10. The smart garden device of claim 8 wherein the preprogrammed storage device is a computer chip.

11. The smart garden device of claim 1 comprising a means for determining, receiving, sending, or processing data regarding the status of two or more components or characteristics of said hydroponics device and a means for displaying the status of two or more components or characteristics of said device.

12. The smart garden device of claim 1 comprising a means for receiving data regarding the status of a photoradiation source, resetting a timer for a requirement to add nutrient, and selection of a timing cycle for a photoradiation source or a pump or both.

13. The smart garden device of claim 1 comprising a timer for a photoradiation source and a pump.

14. The smart garden device of claim 1 further comprising a liquid level gauge and a means for detecting a signal from the liquid level gauge.

15. The smart garden device of claim 1 also comprising a means for sending data to or receiving data from an external preprogrammed or programmable storage device.

16. A smart garden kit comprising said smart garden device of claim 1 and instructions for using said device.

17. The smart garden device of claim 1 further comprising a means for selecting the type of plant or seed, and said type of plant or seed is selected from the group consisting of strawberries, lettuce, tomatoes, herbs, and flowers.

18. A method for growing one or more plants comprising:
a) providing one or more plants or seeds;
b) providing a growing device for growing said one or more plants; said growing device comprising means for delivering water, nutrients and/or light to said plant;
c) providing a smart garden device of claim 1;
d) performing one or more steps selected from the group consisting of determining, receiving, sending, or processing data regarding the status of a component of said wherein said characteristic of component is selected from the group consisting of: need for water, need for nutrients, and need for light;
e) providing water, nutrients, and light to said plant or displaying the status of the need to deliver water, nutrients, and/or light to said plant;
f) allowing said one or more seeds to grow into a plant or said one or more plants to grow;
and repeating steps d-f.

19. A method for growing one or more plants comprising:
a) providing one or more plants or seeds;
b) providing a hydroponics device for growing said one or more plants; said growing device comprising means for delivering water, nutrients and/or light to said plant;
c) providing a smart garden device for a hydroponics device, said hydroponics device having at least one characteristic or component, said smart garden device comprising:
1) means for delivering electricity to said smart garden device;
2) at least one timer; and
3) means for determining, receiving, sending, or processing data regarding the status of said component or characteristic of said hydroponics device.
d) performing one or more steps selected from the group consisting of determining, receiving, sending, or processing data regarding the status of a component or characteristic of said hydroponics device wherein said characteristic of component is selected from the group consisting of: need for water, need for nutrients, and need for light;
e) providing water, nutrients, and light to said plant or displaying the status of the need to deliver water, nutrients, and/or light to said plant;
f) allowing said one or more seeds to grow into a plant or said one or more plants to grow; and
g) repeating steps d-f while said seeds or plants grow.

20. A method for growing one or more plants comprising:
a) providing one or more plants or seeds;
b) providing a hydroponics device for growing said one or more plants; said growing device comprising means for delivering water, nutrients and/or light to said plant;
c) providing a smart garden device for a hydroponics device, said hydroponics device having at least one characteristic or component, said smart garden device comprising:
1) means for delivering electricity to said smart garden device;
2) at least one timer; and
3) means for determining, receiving, sending, or processing data regarding the status of said component or characteristic of said hydroponics device. d) performing one or more steps selected from the group consisting of determining, receiving, sending, or processing data regarding the status of said component or characteristic of said hydroponics device;
e) performing an action that modifies said characteristic or component or displaying the status of the need to perform an action to modify said characteristic or component;
f) allowing said one or more seeds to grow into a plant or said one or more plants to grow; and
g) repeating steps d-f while said seeds or plants grow.
